(19) United States
(12) Patent Application Publication
(10) Pub. No.: US 2015/0375558 A1
(43) Pub. Date: Dec. 31, 2015

(54) COLLAPSIBLE FILE BOX WITH INTEGRATED FILE HANGING RAILS

(71) Applicant: Storex Industries Corporation, LaSalle (CA)

(72) Inventor: Yoav Ben-Or, Dollard des Ormeaux (CA)

(21) Appl. No.: 14/752,510

(22) Filed: Jun. 26, 2015

Related U.S. Application Data
(60) Provisional application No. 62/018,374, filed on Jun. 27, 2014.
(60) Provisional application No. 62/033,427, filed on Aug. 5, 2014.

(51) Int. Cl. B42F 15/00; B65D 43/02; B65D 25/28; B65D 6/18; B65D 21/02

(52) U.S. Cl. CPC B42F 15/0094; B65D 11/1833; B65D 21/0223; B65D 25/2897; B65D 43/0202; B65D 2525/283

(57) ABSTRACT

A collapsible file box with integrated file hanging rails. The collapsible file box can operate in a first position to accommodate hanging file folders suspended on two pairs of rails. Hanging file folders can be suspended in the lateral or the longitudinal direction as the rails are disposed all along the box's sidewalls. The collapsible file box can be configured to a collapsed position where it has a flat profile and its overall height is reduced for easy storage and stackability. A plurality of collapsible file boxes may be stacked on top of each other in uncollapsed, or collapsed position, with, or without the lid.

### RELATED APPLICATIONS

This application is a non-provisional claiming priority to U.S. Provisional Patent Application No. 62/018,374, filed Jun. 27, 2014, and U.S. Provisional Patent Application No. 62/033,427, filed Aug. 5, 2014, the contents of which are incorporated herein by reference in their entirety.

### FIELD OF THE INVENTION

The present invention generally relates to a collapsible file box with integrally mounted rails for hanging file folders.

### SUMMARY OF THE INVENTION

A collapsible file box with integrally mounted rails for hanging file folders is provided. In exemplary embodiments, the collapsible file box of the present invention may comprise of a lid and a box, each of which is formed of injection molded thermoplastic olefin (TPO), similar thermoplastic material, thermosetting plastics materials, and/or elastomers, to name a few.

The collapsible box may be a quadrilateral shape, such as a rectangle, or any other shape with four corners or vertices. In embodiments, the collapsible box may have a width which is sufficient to allow for hanging folders that include standard size documents, such as letter size, legal size, A2, A4, or other standard or non-standard size documents. The collapsible file box may be used to house hanging folders, which are supported at opposed ends by two pairs of integrally mounted parallel rails extending between the box's sidewalls in both the longitudinal and lateral directions so as to form a unitary structure. Hanging file folders may be supported in either direction.

The collapsible file box may be used in a first position, in which it is uncollapsed. The collapsible file box may be transformed from a first position to an inwardly collapsed position, which reduces its overall height and allows it to have a flat profile. The collapsible file box may be stackable in both the first position and the collapsed position, and may be stacked with or without the lid. The lid may be snapped onto the collapsible file box with one hand for convenience.

According to an exemplary embodiment, the collapsible file box may have a quadrilateral base, a first pair of opposing sidewalls and a second pair of opposing sidewalls extending vertically upwards from the base so as to form a storage space. Each sidewall may be pivotally connected to the base to allow the sidewalls to pivot from an upright position to an inwardly collapsed position. The collapsible file box may have a lock to secure the first and second pair of opposing sidewalls in the upright position to form an upright and erect box and a first pair of rails that are integrally mounted in the storage space to a respective one of the first pair of opposing walls.

In embodiments, a second pair of rails can be integrally mounted in the storage space to a respective one of the second pair of opposing walls where the first pair of rails are wider than the second pair of rails.

In embodiments, each of the first pair of opposing side walls can be wider than each of the second pair of opposed side walls so that the first pair of opposing sidewalls and the second pair of opposing side walls form a rectangular shape.

In embodiments, a lid can be attachable to the first pair of opposing sidewalls and the second pair of opposing side walls to enclose the storage space.

In embodiments, the lid can comprise of a recess and the base can be configured for containment inside the recess such that the collapsible file boxes are configured for stackability.

In embodiments, the lid further can comprise of a handle disposed along a sidewall of the lid that engages with one of the first and second pair of opposing side walls.

In embodiments, the box may further comprise of integrated handles that are recessed into the box to aid in lifting.

In embodiments, the first pair of opposing sidewalls can be configured to fold inwardly into a collapsed position, the second pair of opposing sidewalls are configured to fold inwardly into a collapsed position and overlap with the first pair of opposing sidewalls, where the collapsible file box is then in a fully collapsed position and has a reduced overall height for stacking and transport.

In embodiments, the lid can be configured onto the collapsible file box in the fully collapsed position.

In embodiments, the lock can be a plurality of hinges.

In embodiments, the hinges can be piano hinges.

In embodiments, the box can be comprised of plastic.

In embodiments, the box can be comprised of metal.

In embodiments, the box can be comprised of corrugated cardboard.

In embodiments, the rails can be comprised of plastic.

In embodiments, the rails can be comprised of metal.

In embodiments, the lid can be made of plastic.

In embodiments, the first pair of rails at the first pair of opposing sidewalls can be separated from each other by a distance equal to the distance between hooks on standard hanging file folders.

In embodiments, the second pair of rails at the second pair of opposing sidewalls can be separated from each other by a distance equal to the distance between hooks on non-standard sized hanging file folders.

In embodiments, the plurality of hinges at the first pair of opposing sidewalls can be disposed higher in spacial relation to the plurality of hinges at the second pair of opposing sidewalls to prevent interference when each pair of sidewalls are in the collapsed position.

These and other features of this invention are described in, or are apparent from, the following detailed description of various exemplary embodiments of this invention.

### BRIEF DESCRIPTION OF THE DRAWINGS

Exemplary embodiments of the present invention will be described with references to the accompanying figures, wherein:

FIG. 1 is an isometric view of an exemplary embodiment of the collapsible file box made in accordance with the present invention;

FIG. 2 isometric view of an exemplary embodiment of the collapsible file box without the lid made in accordance with the present invention;

FIG. 3 is a top view of an exemplary embodiment of the collapsible file box without the lid made in accordance with the present invention;

FIG. 4 is an isometric view of an exemplary embodiment of the collapsible file box in a collapsed position with the lid;

FIG. 5 is an isometric view of an exemplary embodiment of the collapsible file box in a collapsed position without the lid;

FIG. 6 depicts the collapsible file box with hanging file folders in the longitudinal direction;

FIG. 7 depicts the collapsible file box with hanging file folders in the lateral direction;

FIG. 8 is an isometric view of an exemplary embodiment of a plurality of collapsible file boxes stacked in a collapsed position.

### DETAILED DESCRIPTION OF THE EXEMPLARY EMBODIMENTS

The present invention generally relates to a file box featuring integrally mounted rails for hanging file folders and a collapsible design for easy storage, transporting, and stackability.

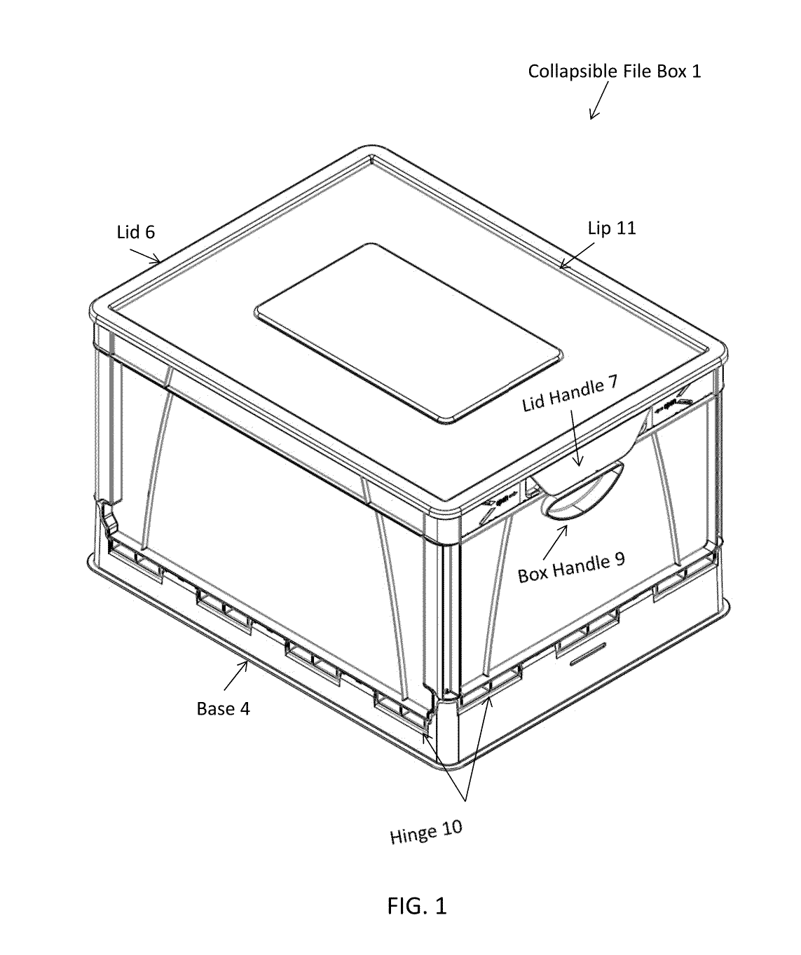

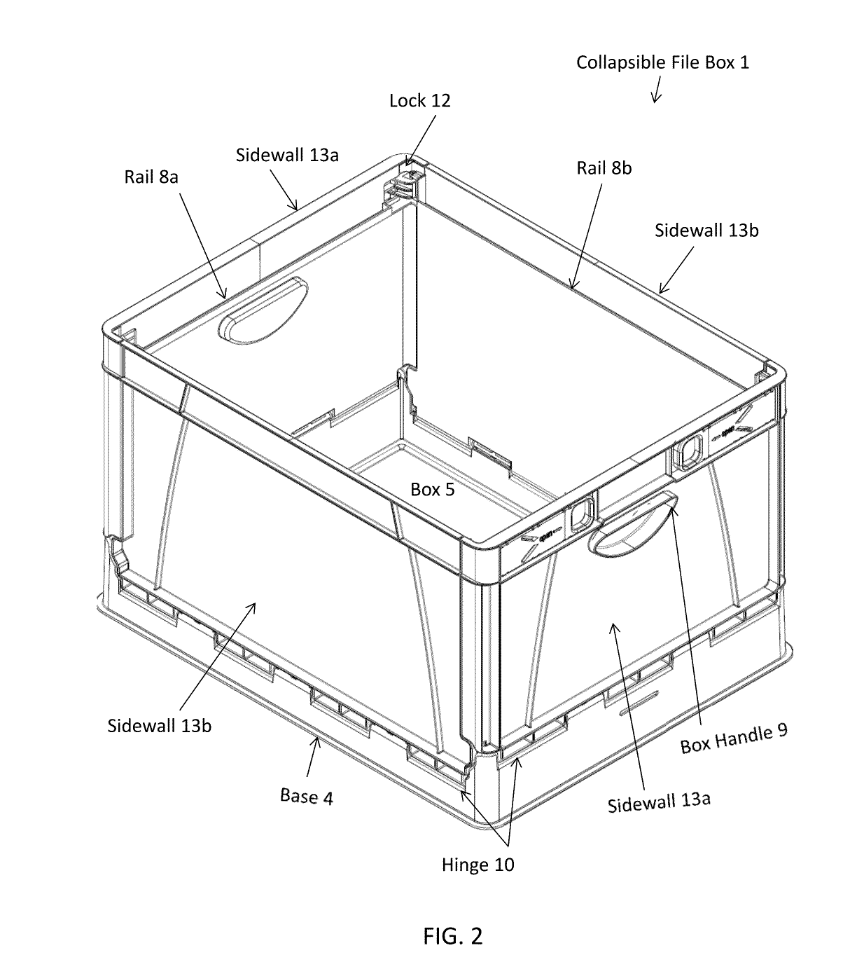

Initially referring to FIGS. 1 and 2, a collapsible file box 1 according to an exemplary embodiment of the present invention includes a base 4, box 5, lid 6, lid handle 7, rails 8a, 8b, box handle 9, hinge 10, lip 11, and locks 12. Box 5 has a rectangular shape, but may be any shape with four corners and vertices and defines a storage space. In an exemplary embodiment, box 5 includes a first and second pair of opposing sidewalls 13a, 13b extending vertically upwards from base 4. Box 5 contains lid 6, which is used to protect the contents of box 5. Lid 6 is configured with lip 11, which allows other collapsible file boxes 1 to be contained when stacked. Lid handle 7 is used to snap lid 6 on top of box 5 by, for example, a friction fit. In embodiments, lid 6 can be snapped on with one hand for convenience. Box handle 9 allows the box 5 to be carried easily by the user.

The first and second pair of opposing sidewalls 13a, 13b are connected to base 4 via hinge 10, which allows sidewalls 13a, 13b to pivot from a first upright position to an inwardly collapsed position. In embodiments, hinge 10 may be a piano hinge or a plurality of piano hinges disposed at each pair of sidewalls 13a, 13b of box 5. It should be appreciated that hinge 10 may be a butt hinge, T-hinge, strap hinge, gate hinge, special purpose hinge, or any other type of hinge that allows each sidewall of box 5 to collapse from a first upright position to an inwardly collapsed position. In an exemplary embodiment, longitudinal sidewalls 13b are collapsed first, while lateral sidewalls 13a are subsequently collapsed over longitudinal sidewalls 13b. In exemplary embodiments, the hinge 10 corresponding to sidewalls 13b is disposed lower in spacial relation to the hinge 10 of sidewalls 13a, which allows box 5 to fold flat, without sidewalls 13a, 13b interfering. In yet other embodiments, sidewalls 13a may be collapsed before 13b. In the fully collapsed position, the overall height of collapsible file box 1 is reduced for easy stacking and transportability.

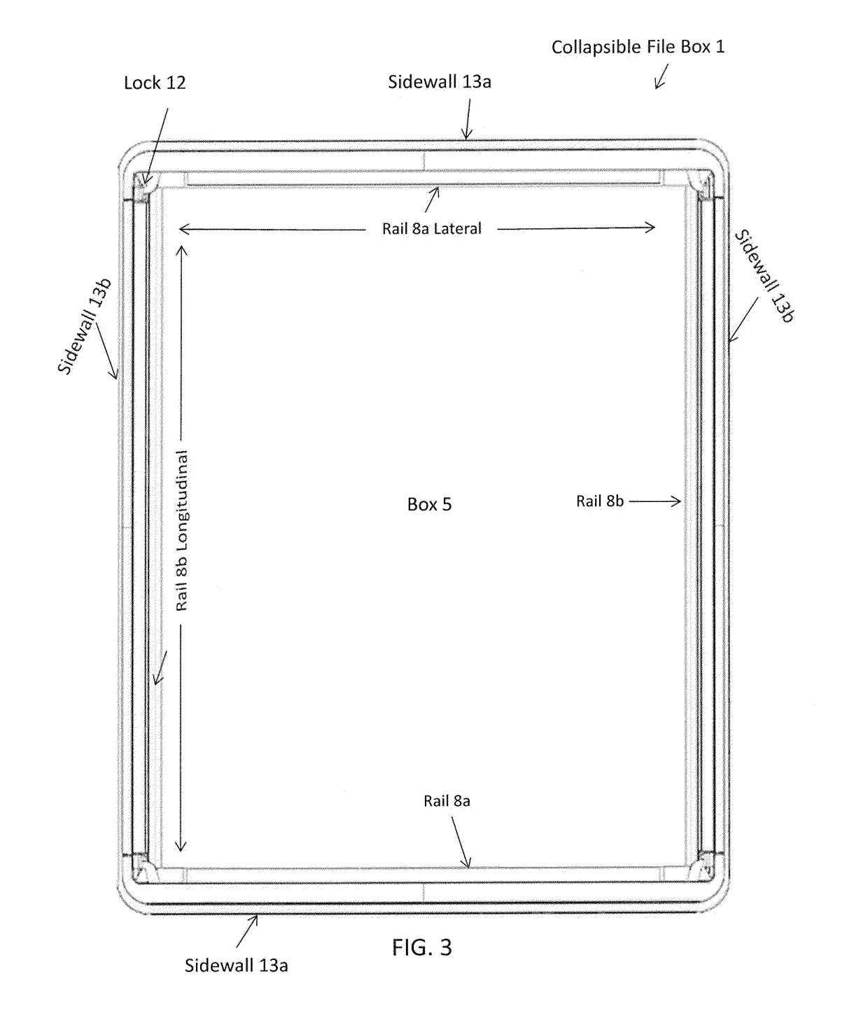

Referring now to FIG. 2 and FIG. 3, locks 12 provide a means of securing the first and second pair of opposing sidewalls 13a, 13b in the upright position to form an upright and erect box 5. A lock 12 is disposed at each corner of box 5. Locks 12 are used to secure the first and second pair of opposing sidewalls 13a,13b in the upright position to form an upright and erect box 5. If a user desires to collapse box 5, the user disengages each lock 12 so that sidewalls 13a, 13b of box 5 may be configured from a first upright position to an inwardly collapsed position. Locks 12 may have a friction fit, snap joint, magnetic lock, threaded fit, interference fit, press fit, or any other lock or fit type, or combination thereof that allows sidewalls 13a, 13b of box 5 to stay in an upright position until a user manipulates sidewalls 13a, 13b to an inwardly collapsed position.

According to an exemplary embodiment of the invention, the collapsible file box 1 may be a rectangular shape. In embodiments, the collapsible file box 1 may be a quadrilateral shape. In yet other embodiments, the collapsible file box 1 may be any other shape with four corners or vertices. In an exemplary embodiment, collapsible file box 1 is wide enough in both longitudinal and lateral directions sufficient to allow for hanging folders that include standard size documents, such as letter size, legal size, A2, A4, or other standard or non-standard size documents. The hanging file folders are supported at opposed ends by two pairs of opposing parallel rails 8a, 8b extending between sidewalls 13a, 13b in both the longitudinal and lateral directions. Rails 8a, 8b are integrally mounted within box 5 so as to form a unitary structure. In an exemplary embodiment, rails 8a are mounted in box 5 at upper ends of sidewalls 13a and rails 8b are mounted at upper ends of sidewalls 13b. In embodiments, the first pair of rails 8a at sidewalls 13a may be separated from each other by a distance equal to the distance between hooks on standard hanging file folders. Similarly, the second pair of rails 8b at sidewalls 13b may be separated from each other by a distance equal to the distance between hooks on non-standard sized hanging file folders. In other embodiments, rails 8a, 8b are disposed at nonstandard widths to allow for nonstandard hanging file folders in either direction.

In an exemplary embodiment, rails 8a, 8b are disposed below lock 12. In other embodiments, rails 8a, 8b may be disposed above lock 12. In an exemplary embodiment, rails 8a, 8b are permanent fixtures and may be welded, molded, or glued to sidewalls 13a, 13b. In yet other embodiments, rails 8a, 8b may be raised or lowered on tracks disposed on sidewalls 13a, 13b to permit the hanging of file folders with different heights. In other embodiments, rails 8a, 8b may be made of metal, plastic, or any other durable material.

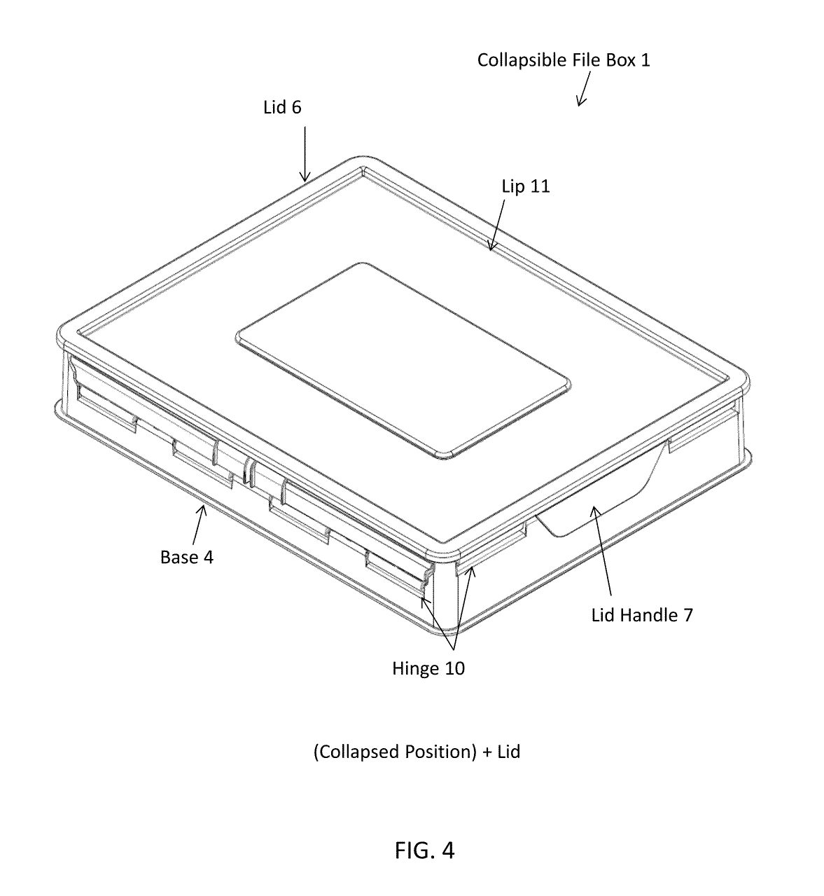

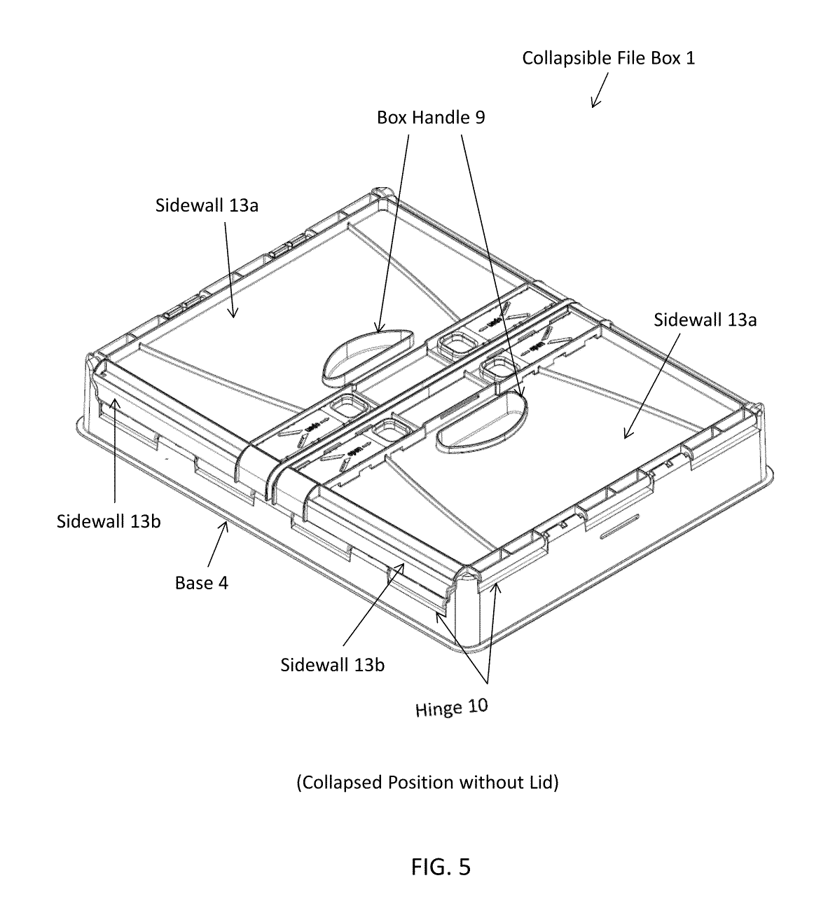

Referring now to FIG. 4 and FIG. 5, collapsible file box 1 is shown in the collapsed position with and without lid 6. It should be appreciated that lid 6 snaps into place whether or not box 5 is in a first upright position or a collapsed position.

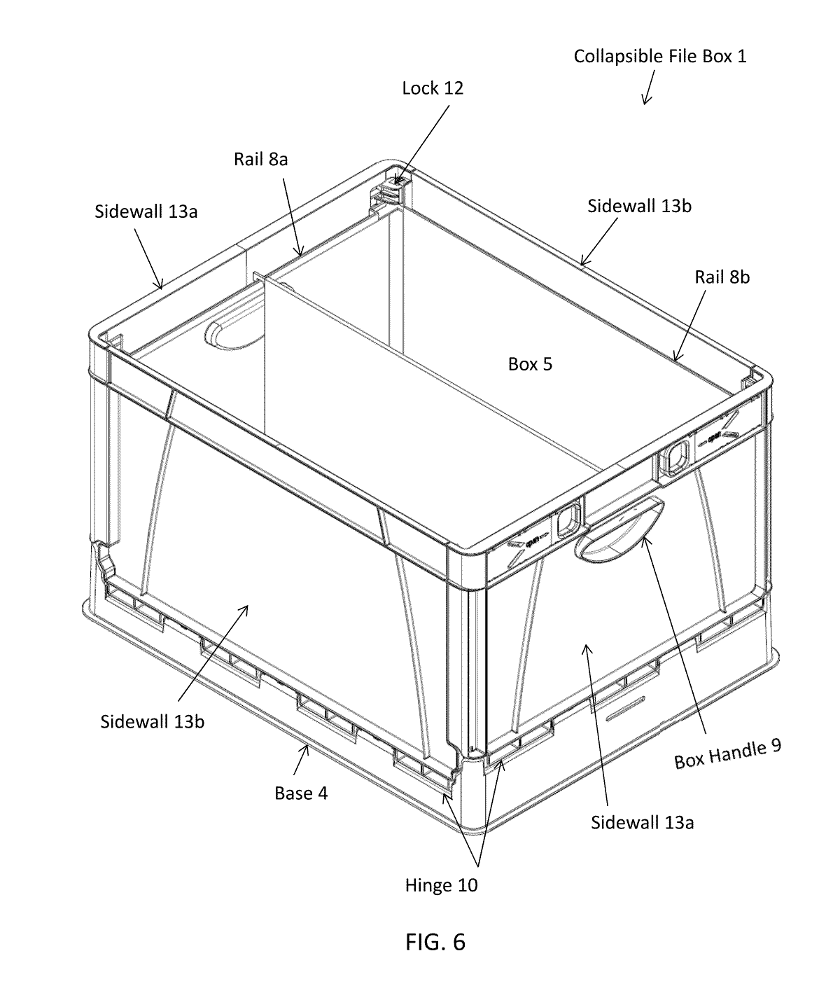

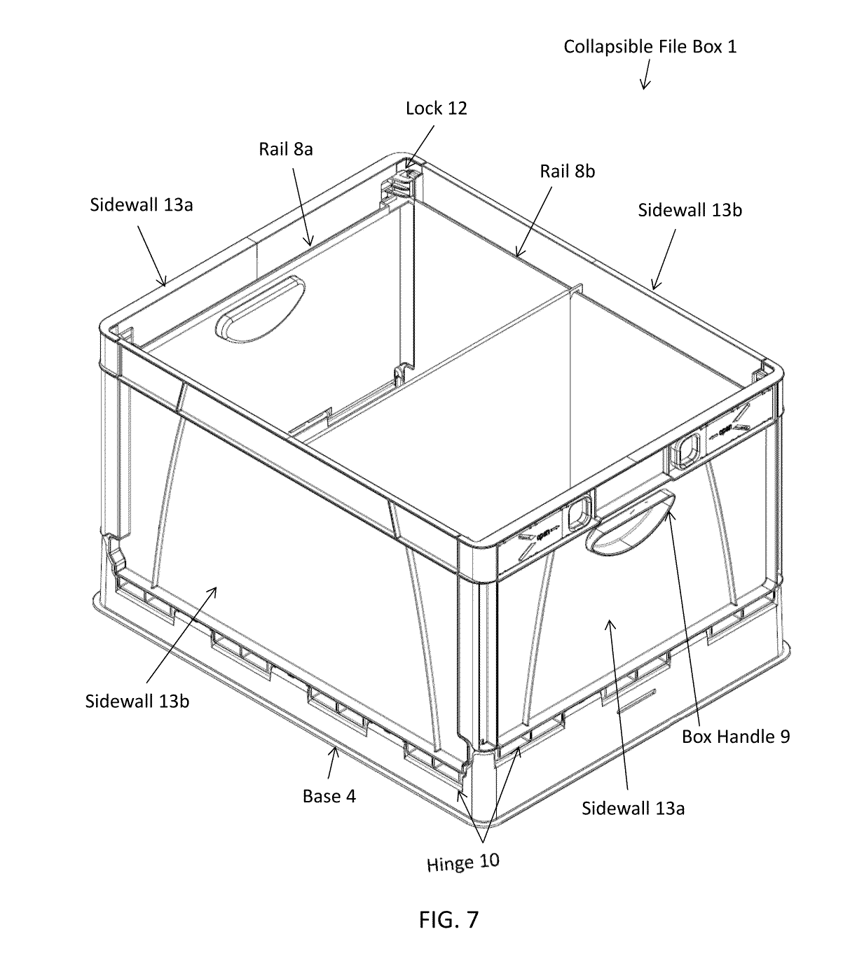

FIG. 6 and FIG. 7 depict collapsible file box 1 without lid 6 showing hanging file folders suspended on rails 8a and 8b. In an exemplary embodiment, rails 8a, 8b are disposed fully along sidewalls 13a, 13b, allowing the hanging file folders to be hung in both longitudinal and lateral directions, allowing for versatility.

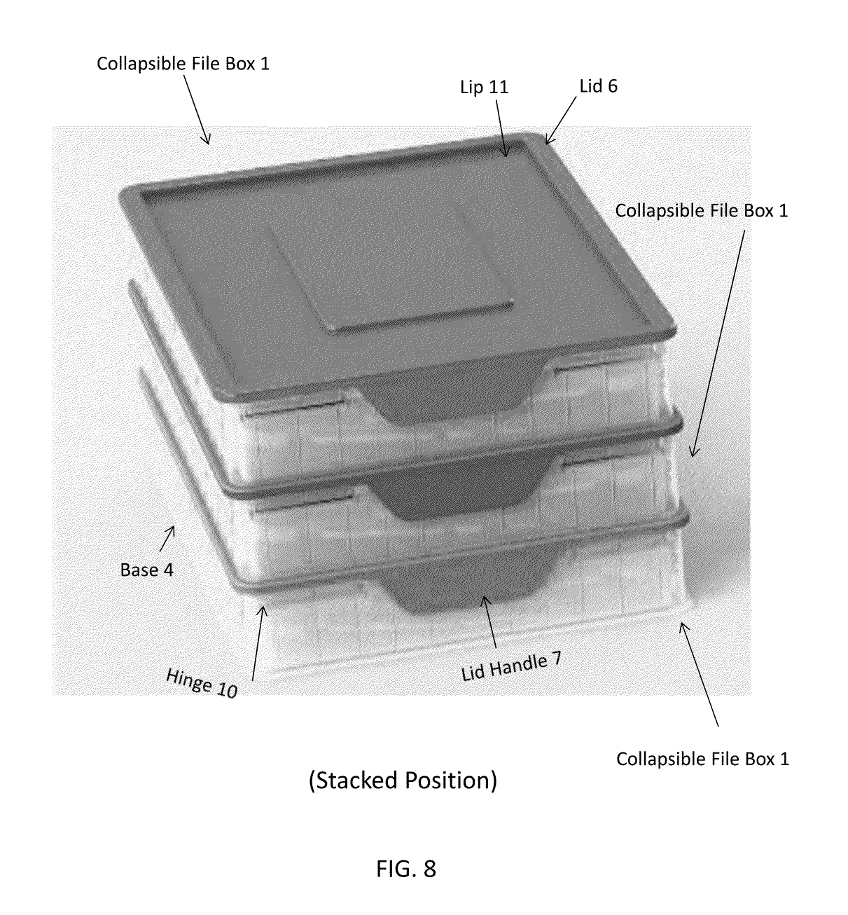

Referring now to FIG. 8, a plurality of collapsible file boxes 1 are shown stacked in a collapsed position. Configuring collapsible file box 1 in a collapsed position allows for easy storage and stackability. In embodiments, hanging file folders and other items can still be stored in box 5 even when in collapsed position. In other embodiments, a plurality of collapsible file boxes 1 can be stacked in the upright position.

Now that embodiments of the present invention have been shown and described in detail, various modifications and improvements thereon will become readily apparent to those skilled in the art. Accordingly, the exemplary embodiments of the invention, as set forth above, are intended to be illustrative, not limiting. The spirit and scope of the present invention is to be construed broadly.

1. A collapsible file box comprising:
a base;
a first pair of vertically extending and opposing side walls pivotally attached to the base so that the first pair of opposing side walls are pivotable between an upright configuration and a collapsed configuration;
a second pair of vertically extending and opposing side walls pivotally attached to the base so that the second pair of opposing side walls are pivotable between an upright configuration and a collapsed configuration;
a storage space defined by the base and the first and second pair of opposing side walls;
a first pair of rails each extending along a corresponding one of the first pair of opposing side walls and configured to support corresponding ends of a hanging file folder within the storage space;
one or more locking members that releasably hold the first and second pair of opposing side walls in the upright configuration; and
a lid disposed over the storage space and releasably fixed to the first and second opposing side walls.

2. The collapsible file box of claim 1, wherein the first and second pair of opposing side walls are pivotally attached to the base by corresponding hinges.

3. The collapsible file box of claim 2, wherein the hinges that pivotally attach the first pair of opposing side walls are disposed at a vertical position that is different from the vertical position of the hinges that pivotally attach the second pair of opposing side walls.

4. The collapsible file box of claim 2, wherein the hinges are of a type selected from the group consisting of: piano hinge, butt hinge, T-hinge, strap hinge, gate hinge and special purpose hinge.

5. The collapsible file box of claim 1, further comprising a second pair of rails each extending along a corresponding one of the second pair of opposing side walls and configured to support ends of a hanging file folder within the storage space.

6. The collapsible file box of claim 5, wherein the first pair of opposing side walls are spaced from one another by a first distance and the second pair of opposing side walls are spaced from one another by a second distance, the first and second distances being different from one another so that the first pair of rails support hanging file folders having a first size and the second pair of rails support hanging file folders having a second size.

7. The collapsible file box of claim 6, wherein the first and second sizes are standard size, A2, A4, letter size, legal size, standard or non-standard size.

8. The collapsible file box of claim 5, wherein the first and second pair of rails form a unitary structure with the first and second opposing side walls.

9. The collapsible file box of claim 1, wherein the box has a first vertical height when the first and second opposing side walls are in their upright configurations and a second vertical height when the first and second opposing side walls are in their collapsed configuration, the first vertical height being greater than the second vertical height.

10. The collapsible file box of claim 1, wherein the locking members comprise locking members of the type selected from the group consisting of: friction fit, snap joint, magnetic lock, threaded fit, interference fit, press fit and combinations thereof.

11. The collapsible file box of claim 1, wherein the lid comprises at least one handle.

12. The collapsible file box of claim 1, wherein at least one of the first and second pairs of vertically extending side walls comprise handles.

13. The collapsible file box of claim 1, wherein the base has a quadrilateral shape.

14. The collapsible file box of claim 1, wherein the base has a square or rectangular shape.

15. The collapsible file box of claim 1, wherein the box is configured to be stacked with one or more other like boxes.

16. The collapsible file box of claim 15, wherein the lid comprises a protruding portion or a recessed portion that mates with a corresponding protruding portion or recessed portion on the base of a like box stacked on top of the box.

17. A stack of collapsible file boxes, each box comprising:
a base;
a first pair of vertically extending and opposing side walls pivotally attached to the base so that the first pair of opposing side walls are pivotable between an upright configuration and a collapsed configuration;
a second pair of vertically extending and opposing side walls pivotally attached to the base so that the second pair of opposing side walls are pivotable between an upright configuration and a collapsed configuration;
a storage space defined by the base and the first and second pair of opposing side walls;
a first pair of rails each extending along a corresponding one of the first pair of opposing side walls and configured to support corresponding ends of a hanging file folder within the storage space;
one or more locking members that releasably hold the first and second pair of opposing side walls in the upright configuration; and
a lid disposed over the storage space and releasably fixed to the first and second opposing side walls,
the base configured to be stacked on top of a corresponding lid of another box and the lid configured to hold the corresponding base of another box.

18. The stack of collapsible file boxes, wherein the boxes are stacked when their first and second pair of opposing side walls are in the collapsed configuration.
